(19) United States
(12) Patent Application Publication
(10) Pub. No.: US 2026/0254828 A1
(43) Pub. Date: Aug. 27, 2026

(54) Automatic Generation of Threat Hunting Queries Based on Descriptions of Indicators of Compromise and Behavior Derived from Graphs Corresponding to Threat Reports

(71) Applicant: International Business Machines Corporation, Armonk, NY (US)

(72) Inventors: Kevin Eykholt, White Plains, NY (US); Hailun Ding, Piscataway, NJ (US); Youngja Park, Princeton, NJ (US); Xiaokui Shu, Ossining, NY (US); Jiyong Jang, Chappaqua, NY (US)

(21) Appl. No.: 19/063,599

(22) Filed: Feb. 26, 2025

(51) Int. Cl. H04L 9/40

(52) U.S. Cl. CPC H04L 63/1425; H04L 63/1416

(57) ABSTRACT

Threat report processing is provided. A composite graph for a threat report corresponding to a cybersecurity threat is generated by merging subgraphs corresponding to cyberattack-related sentences identified in the threat report into one or more graphs. The composite graph of the threat report corresponding to the cybersecurity threat is analyzed to identify indicators of compromise associated with system entities and indicators of behavior associated with the subgraphs comprising the composite graph. Descriptions of the indicators of compromise associated with the system entities and the indicators of behavior associated with the subgraphs comprising the composite graph are generated based on analyzing the composite graph of the threat report corresponding to the cybersecurity threat. A threat hunting query corresponding to the cybersecurity threat is generated based on the descriptions of the indicators of compromise associated with the system entities and the indicators of behavior associated with the subgraphs comprising the composite graph.

### BACKGROUND

The disclosure relates generally to threat hunting and more specifically to threat hunting query generation.

Threat hunting, also known as cyberthreat hunting, is a proactive approach to identifying currently ongoing or previously unknown cybersecurity threats in an entity's environment. The entity may be, for example, an enterprise, company, business, organization, institution, agency, or the like. A cybersecurity threat, or cyberthreat, is an indication that a malicious actor is attempting to gain unauthorized access to a network to launch a cyberattack.

Threat hunting helps an entity strengthen its cybersecurity against, for example, malware, insider threats, and other cyberattacks that might otherwise go unnoticed. Cybersecurity analysts use threat hunting to search for, log, monitor, and mitigate cyberthreats before the cyberthreats can cause extensive problems.

### SUMMARY

According to one illustrative embodiment, a method is provided. A computer, using a large language model, generates a composite graph for a threat report corresponding to a cybersecurity threat by merging subgraphs corresponding to cyberattack-related sentences identified in the threat report into one or more connected graphs. The computer, using the large language model, analyzes the composite graph of the threat report corresponding to the cybersecurity threat to identify indicators of compromise associated with system entities and indicators of behavior associated with the subgraphs comprising the composite graph. The computer generates descriptions of the indicators of compromise associated with the system entities and the indicators of behavior associated with the subgraphs comprising the composite graph based on analyzing the composite graph of the threat report corresponding to the cybersecurity threat. The computer generates a threat hunting query corresponding to the cybersecurity threat based on the descriptions of the indicators of compromise associated with the system entities and the indicators of behavior associated with the subgraphs comprising the composite graph. According to other illustrative embodiments, a computer system and computer program product are provided.

### BRIEF DESCRIPTION OF THE DRAWINGS

FIG. 1 is a pictorial representation of a computing environment in which illustrative embodiments may be implemented;

FIG. 2 is a diagram illustrating an example of a threat hunting query generation system based on threat report processing in accordance with an illustrative embodiment;

FIG. 3 is a diagram illustrating an example of a subgraph in accordance with an illustrative embodiment;

FIG. 4 is a diagram illustrating an example of an enriched subgraph in accordance with an illustrative embodiment;

FIG. 5 is a diagram illustrating an example of a composite graph filtering process in accordance with an illustrative embodiment; and

FIGS. 6A-6C are a flowchart illustrating a process for generating indicators of compromise and indicators of behavior from threat report graphs in accordance with an illustrative embodiment.

### DETAILED DESCRIPTION

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A CPP embodiment is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

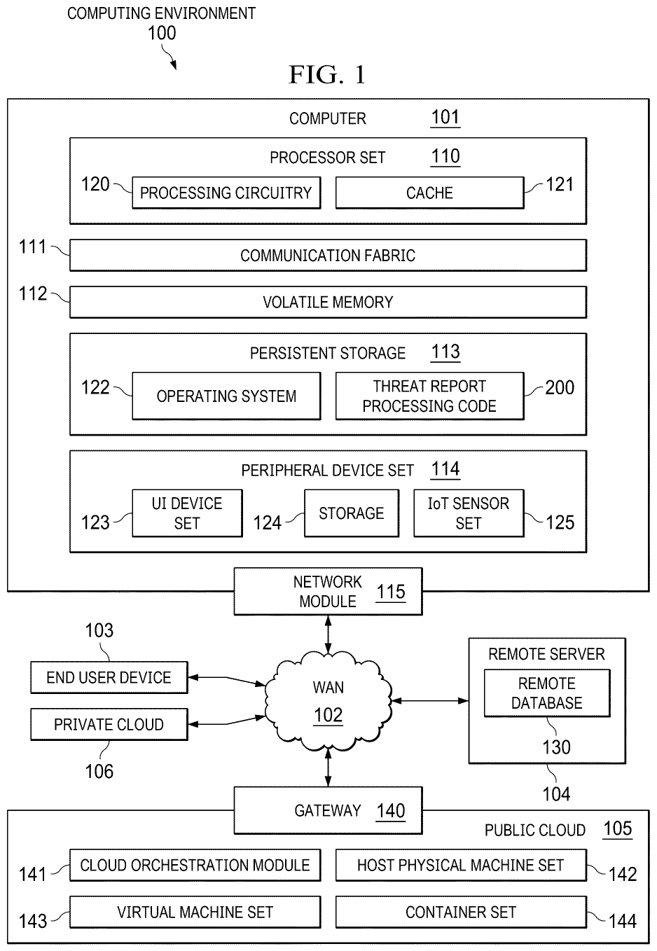

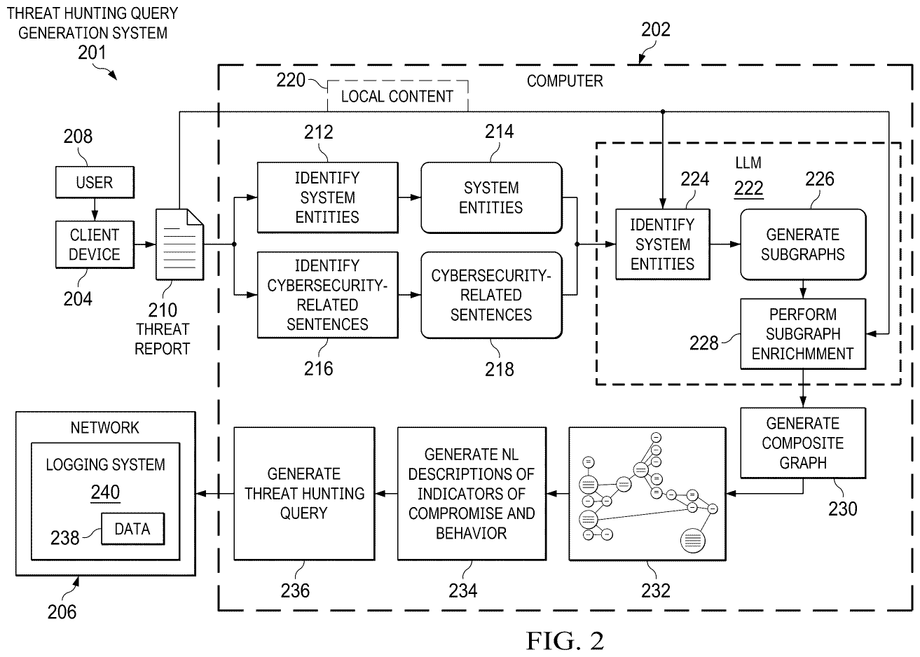

With reference now to the figures, and in particular, with reference to FIG. 1 and FIG. 2, diagrams of data processing environments are provided in which illustrative embodiments may be implemented. It should be appreciated that FIG. 1 and FIG. 2 are only meant as examples and are not intended to assert or imply any limitation with regard to the environments in which different embodiments may be implemented. Many modifications to the depicted environments may be made.

FIG. 1 shows a pictorial representation of a computing environment in which illustrative embodiments may be implemented. Computing environment 100 contains an example of an environment for the execution of at least some of the computer code involved in performing the inventive methods of illustrative embodiments, such as threat report processing code 200.

For example, threat report processing code 200 uses natural language processing (NLP) and a large language model (LLM) to automatically identify cybersecurity-related system entities and system interactions between the cybersecurity-related system entities mentioned in a threat report. Threat report processing code 200 then generates a graph corresponding to that particular threat report where nodes in the graph represent the system entities and edges between nodes represent the system interactions between the system entities described in the threat report. Afterward, threat report processing code 200 converts the graph into natural language descriptions of indicators of compromise and indicators of behavior, which threat report processing code 200 or a cybersecurity analyst can use to identify the presence of a cybersecurity threat in a network or computer system.

An indicator of compromise is an artifact observed on a network or in a computer system, such as a file, that, with high confidence, indicates a computer intrusion. An indicator of compromise is usually presented as an identifier attribute of the artifact, such as, for example, a checksum of a file, an internet protocol (IP) address of a host, or the like. An indicator of behavior is a description of a behavior of one or more system entities observed on a network or in a computer system that, with high confidence, indicates a computer intrusion. An indicator of behavior is presented as a pattern written in natural language, a structured threat information expression (STIX), a query language (e.g., SQL or Kestrel), or the like.

Threat report processing code 200 can utilize a query generation engine to automatically generate a threat hunting query based on the natural language descriptions of indicators of compromise and indicators of behavior. Alternatively, the cybersecurity analyst can create the threat hunting query manually from the natural language descriptions of indicators of compromise and indicators of behavior. Threat report processing code 200 can automatically execute the threat hunting query on data of a logging system associated with a network or computer system to determine whether the cybersecurity threat corresponding to that particular threat hunting query is currently present in that network or computer system. Upon detecting that the cybersecurity threat is present based on executing the threat hunting query on the data of the logging system associated with the network or computer system, threat report processing code 200 automatically performs a set of action steps to mitigate the detected cybersecurity threat. The set of action steps can include, for example, at least one of sending a notification to a cybersecurity analyst regarding the detected cybersecurity threat, isolating the network or system, identifying the source of the cybersecurity threat, closing network connections corresponding to the source of the cybersecurity threat, running software to find and eliminate the cybersecurity threat in the network or system, and the like.

In addition to threat report processing code 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and threat report processing code 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a mainframe computer, quantum computer, desktop computer, laptop computer, tablet computer, or any other form of computer now known or to be developed in the future that is capable of, for example, running a program, accessing a network, and querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods of illustrative embodiments may be stored in threat report processing code 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports, and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open-source portable operating system interface-type operating systems that employ a kernel.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks, and even connections made through wide area networks such as the internet. In various embodiments, UI device set 123 may include components such as a display screen, speaker, microphone, wearable devices (such as smart glasses and smart watches), keyboard, mouse, printer, touchpad, and haptic devices.

Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (e.g., where computer 101 locally stores and manages a large database) then this storage may be provided by peripheral storage devices designed for storing very large amounts of data, such as a storage area network (SAN) that is shared by multiple, geographically distributed computers.

IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (e.g., embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (e.g., the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

EUD 103 is any computer system that is used and controlled by an end user (e.g., a cybersecurity analyst who utilizes the threat report processing services provided by computer 101), and may take any of the forms discussed above in connection with computer 101. EUD 103 typically receives helpful and useful data from the operations of computer 101. For example, in a hypothetical case where computer 101 is designed to provide a cybersecurity threat notification to the end user, this cybersecurity threat notification would typically be communicated from network module 115 of computer 101 through WAN 102 to EUD 103. In this way, EUD 103 can display, or otherwise present, the cybersecurity threat notification to the end user. In some embodiments, EUD 103 may be a client device, such as a thin client, heavy client, mainframe computer, desktop computer, laptop computer, tablet computer, smart phone, and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a cybersecurity threat notification based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single entity. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Public cloud 105 and private cloud 106 are programmed and configured to deliver cloud computing services and/or microservices (not separately shown in FIG. 1). Unless otherwise indicated, the word “microservices” shall be interpreted as inclusive of larger “services” regardless of size. Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of application programming interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

As used herein, when used with reference to items, “a set of” means one or more of the items. For example, a set of clouds is one or more different types of cloud environments. Similarly, “a number of,” when used with reference to items, means one or more of the items. Moreover, “a group of” or “a plurality of” when used with reference to items, means two or more of the items.

Further, the term “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item B. This example may also include item A, item B, and item C or item B and item C. Of course, any combinations of these items may be present. In some illustrative examples, “at least one of” may be, for example, without limitation, two of item A, one of item B, and ten of item C, or four of item B and seven of item C, or other suitable combinations.

Cybersecurity analysts are constantly monitoring their technical infrastructure to identify and mitigate potential cybersecurity threats. To this end, extensive logging is performed to comprehensively record all network and system activity, which cybersecurity analysts can review later. When new cybersecurity incidents are discovered, the cybersecurity analysts document the findings and publish threat reports to raise awareness regarding these new cybersecurity incidents. These threat reports, which are published on a near daily basis, provide the latest information regarding emerging cybersecurity threats. These threat reports detail the cyberattack lifecycle, how to identify potential compromise, and, sometimes, provide potential mitigations.

However, transforming a threat report into actionable cybersecurity information is difficult because of, for example, threat report length, threat report complexity, diverse systems and languages, and the like. Regarding threat report length, some threat reports can include tens or hundreds of pages depending on the complexity of the cybersecurity threat or variety of cybersecurity threat implementations in the real world. Regarding threat report complexity, threat reports often require a high level of technical expertise by the reader to understand the content, including knowledge in cybersecurity and systems. Regarding diverse systems and languages, even when cybersecurity analysts understand the content of a threat report, it is difficult to translate the threat report content into actionable cybersecurity information due to the wide variety of logging systems and threat hunting query languages.

Illustrative embodiments take into account and address the issues noted above by automatically processing threat reports, which include system entities and system interactions that are recorded by a logging system, and generating actionable cybersecurity information from the threat reports. For example, illustrative embodiments receive a threat report as input, generate a graph based on the content of the threat report, where nodes represent system entities and edges represent system interactions between the system entities, and then generate natural language descriptions of indicators of compromise and indicators of behavior based on the generated graph. These natural language descriptions of the indicators of compromise and the indicators of behavior enable illustrative embodiments to automatically generate threat hunting queries using a query generation engine or enable a cybersecurity analyst to manually create threat hunting queries. The pipeline of illustrative embodiments includes system entity extraction, attack sentence detection, subgraph generation, composite graph generation, and natural language descriptions of indicators of compromise and indicators of behavior generation.

For a given threat report, illustrative embodiments first extract system entities from the threat report using a combination of NLP and machine learning. Illustrative embodiments train the extraction models to recognize cybersecurity-related system entities, such as, for example, internet protocol (IP) addresses, file names, hash values, processes, network hosts, and the like.

Afterward, illustrative embodiments identify cyberattack-related sentences within the threat report that describe cybersecurity incidents, such as, for example, malware activities, system vulnerabilities, insider threats, and the like. For example, illustrative embodiments can generate a cyberattack-related sentence confidence score for each respective sentence in a threat report using a machine learning model trained on a plurality of positive and negative cyberattack-related sentence samples. Illustrative embodiments select only those sentences in the threat report having a corresponding confidence score greater than or equal to a defined minimum confidence score as cyberattack-related sentences. While identifying and extracting the cyberattack-related sentences in a threat report, illustrative embodiments ignore all other irrelevant information contained in the threat report. By ignoring the irrelevant information, illustrative embodiments mitigate an issue associated with LLM hallucinations.

Then, illustrative embodiments generate a subgraph for each cyberattack-related sentence identified in the threat report, along with the local sentence context of that particular cyberattack-related sentence. For example, the local sentence context includes the identified cyberattack-related sentence and, potentially, one or more sentences surrounding (e.g., before and/or after) the identified cyberattack-related sentence that provide additional context or details corresponding to that particular identified cyberattack-related sentence. For each local sentence context corresponding to a cyberattack-related sentence and the system entities described therein, illustrative embodiments use an LLM to identify the system interactions between the system entities described explicitly or implicitly in the local sentence context. The system interactions between system entities describe the relationship between the system entities with regard to system operations, such as, for example, login, download, execute, delete, and the like. A system interaction should include a source system entity and a destination system entity. Then, illustrative embodiments generate a subgraph for each respective cyberattack-related sentence by connecting nodes representing the system entities using edges representing the system interactions between the system entities.

Subsequently, illustrative embodiments combine all of the subgraphs representing the cyberattack-related sentences identified in the threat report into a composite graph corresponding to the threat report by merging nodes representing the same system entities and removing redundant subgraphs and non-interactional subgraphs. A non-interactional subgraph does not contain a system interaction between system entities, but merely contains other types of information, such as, for example, name of a malware owner or the like. Afterward, illustrative embodiments generate a natural language description for each node that provides an indicator of compromise for the corresponding system entity and a natural language description of each subgraph in the composite graph that provides an indicator of behavior for the corresponding system interaction. Illustrative embodiments or a cybersecurity analyst can use the natural language descriptions of the nodes representing system entities and the natural language descriptions of the subgraphs representing cyberattack-related sentences describing system interactions to determine how to query data being recorded by a logging system to identify cybersecurity threats in a network or computer system.

Thus, illustrative embodiments automatically generate natural language descriptions of indicators of compromise and indicators of behavior based on analyzing composite graphs representing threat reports. In addition, illustrative embodiments provide an LLM-powered graph generation component that converts threat reports into the composite graphs that describe the system interactions between identified system entities (e.g., files, processes, IP addresses, network hosts, users, and the like). For example, after identifying the system entities in the threat reports, illustrative embodiments perform cyberattack-related sentence identification, system entity interaction identification, subgraph generation, subgraph enrichment, and composite graph generation. Further, illustrative embodiments generate natural language descriptions of indicators of compromise and indicators of behavior based on using an LLM to analyze the composite graph that shows and describes the system entity interactions identified by illustrative embodiments within a threat report.

In order to extract actionable cybersecurity information from a threat report that illustrative embodiments or a cybersecurity analyst can use for generating threat hunting queries, illustrative embodiments first need to identify the system entities described in the threat report. Illustrative embodiments may utilize any existing system entity extraction method to obtain a list of system entities identified by illustrative embodiments within the threat report.

However, a threat report can be extensive and can often contain irrelevant, non-actionable information, such as, for example, threat report author information, background on threat actors, cybersecurity threat references, filler sentences, and the like. These irrelevant, non-actionable information sentences add noise and, therefore, decrease the accuracy of extracted cybersecurity-related information. It should be noted that LLMs are prone to hallucinations and can be distracted by excessive irrelevant information contained in a threat report. As a result, illustrative embodiments first identify relevant sentences that appear to describe cybersecurity-related activities. This initial sentence filtering by illustrative embodiments enables the LLM to focus on relevant sentences, thereby mitigating issues related to LLM hallucinations. Illustrative embodiments can perform this sentence filtering in a number of ways, such as, for example, training a classification model on a multitude of positive and negative cybersecurity-related sentence examples.

Next, illustrative embodiments perform system entity identification and system entity interaction identification by analyzing the local sentence context of each identified cyberattack-related sentence in the threat report. Illustrative embodiments define the local sentence context of a cyberattack-related sentence as one or more sentences before and after the cyberattack-related sentence, thus ensuring that illustrative embodiments do not miss relevant details regarding system entity interactions.

For example, assume illustrative embodiments have identified the following cyberattack-related sentence: “A file is downloaded from fakewebsite.xx and executed by the attacker.” In addition, also assume illustrative embodiments have identified the following file names: “cmd_bad.exe,” “badguy.sh,” and “bigbad.py” in the local sentence context of the above cyberattack-related sentence. In this illustrative example, the cyberattack-related sentence above only contains the interaction between an unspecified file and fakewebsite. xx. By including the local sentence context surrounding the cyberattack-related sentence, illustrative embodiments can now identify the interactions between the named files (i.e., cmd_bad.exe, badguy.sh, and bigbad.py) included in the local sentence context with the website (i.e., fakewebsite.xx) mentioned in the cyberattack-related sentence.

The LLM is instruction trained and provided with instructions and examples for the task of identifying the system interactions between the system entities without additional training. In the illustrative example above, the system entities are the files and the website. If illustrative embodiments identify a system entity not contained in the list of system entities generated earlier by illustrative embodiments, then illustrative embodiments correlate that system entity with the most similar system entity contained in the list of system entities. Illustrative embodiments generate a subgraph containing nodes representing the system entities and edges between the nodes representing the system interactions between the system entities. It should be noted that a subgraph may contain two or more system entities with corresponding system interactions.

Threat reports often contain additional information or details that can assist illustrative embodiments or cybersecurity analysts in generating threat hunting queries. For example, a malicious process may use a number of aliases or a file exfiltration process may use several shell commands to avoid detection. Illustrative embodiments can enrich subgraphs by adding this additional information or details contained in threat reports to the subgraphs.

For example, illustrative embodiments can utilize the LLM to analyze the threat report to identify the additional information or details based on a predefined list of system entity attributes, such as, for example, alternative process names, associated hash information, related command lines, associated vulnerability types, threat timeline information, threat actors, and the like, and a predefined list of system interactions, such as, for example, source system entity, destination system entity, system interaction type, and the like. Illustrative embodiments augment the nodes and edges representing the identified system entities and their corresponding system interactions in the subgraph with this additional information.

It should be noted that because illustrative embodiments generate each subgraph independently, it is likely that illustrative embodiments will detect duplicate nodes and/or edges representing system entities and their corresponding system interactions. Illustrative embodiments perform composite graph generation by merging all the subgraphs into one or more connected graphs representing a particular threat report. Illustrative embodiments merge the subgraphs based on nodes that share common system entity attributes. The degree of subgraph merging by illustrative embodiments depends on the strictness setting. For example, the most restrictive setting would allow illustrative embodiments to only merge subgraphs that are exactly the same with respect to all system entity attributes. However, a less restrictive setting would allow illustrative embodiments to merge subgraphs based merely on semantically similar system entity names.

Moreover, illustrative embodiments may perform additional composite graph cleanup to increase the precision of the composite graph. The additional cleanup may include, for example, removing orphaned nodes as orphaned nodes are implicitly not interactional, merging semantically similar edges representing similar system entity interactions, and the like.

For example, assume illustrative embodiments identify the following three sentences in a threat report: 1) “Example.pdf is downloaded from Example.com;” 2) “A process downloads Example. pdf from Example. com;” and 3) “Attackers connect to and download Example. pdf from Example.com.” It should be noted that all three sentences above describe a download interaction between Example. pdf and Example. com. However, the difference in verb usage in the three sentences above causes illustrative embodiments to generate three different edge names, labels, or types. To avoid edge redundancies, illustrative embodiments can utilize a mapping function to identify and merge semantically similar edge names. One possible mapping function solution is for illustrative embodiments to provide the LLM with a plurality of different edge names and then ask the LLM to perform the edge name mapping for merging semantically similar edge names. However, it should be noted that illustrative embodiments may utilize fixed mapping functions in addition to, or instead of, the LLM.

Given a particular threat report as input, illustrative embodiments automatically generate a composite graph for that particular threat report describing system entities and the system interactions between the system entities. Each node in the composite graph represents an indicator of compromise for a corresponding system entity and each subgraph of the composite graph represents an indicator of behavior for a corresponding system interaction between system entities. Using a text template, illustrative embodiments walk through the composite graph and generate a natural language interrogative sentence (i.e., a question) corresponding to each indicator of compromise and indicator of behavior. Illustrative embodiments utilize the natural language interrogative sentences for the indicators of compromise and the indicators of behavior to generate a threat hunting query.

Moreover, illustrative embodiments can utilize threat hunting applications as well. Illustrative embodiments can rank the interrogative sentences by threat hunting relevance based on the relevance to a specific query by a cybersecurity analyst regarding a particular cybersecurity threat. For example, the cybersecurity analyst may only be interested in finding exfiltration indicators of behavior. Furthermore, illustrative embodiments enable a threat report questions and answers pipeline where illustrative embodiments execute the cybersecurity analyst's specific query against the composite graph generated by illustrative embodiments. This specific type of query by the cybersecurity analyst can be answerable by the composite graph for the indicators of compromise and indicators of behavior related to the particular cybersecurity threat of interest. These cybersecurity analyst queries can also require additional processing for generating and executing threat hunting queries based on the natural language descriptions of the indicators of compromise and indicators of behavior that illustrative embodiments generated based on the composite graph or for identifying a kill chain that breaks down a cyberattack into stages based on the composite graph so that illustrative embodiments can stop the cyberattack at a particular stage.

It should be noted that there are existing solutions for extracting actionable cybersecurity threat information from threat reports. One existing solution utilizes NLP for normalizing sentences in threat reports. In other words, this existing solution must perform sentence normalization due to its usage of NLP. Because the LLM of illustrative embodiments can handle diverse sentence formats, illustrative embodiments do not need to perform sentence normalization. Also, this existing solution uses pre-defined dictionaries to homogenize the vocabulary of sentences during extraction of the cybersecurity threat information. Although system entity interactions may be fixed, the words used to describe those interactions can be varied. As such, if a threat report uses a phrase or word that is not included in the dictionary, this existing solution will fail to recognize that particular phrase or word and, therefore, miss the system entity interaction. In contrast, the LLM of illustrative embodiments is trained on a massive amount of text and has learned the explicit and implicit relationships between these phrases and words to detect system entity interactions even though the words to describe those interactions are varied.

Another existing solution analyzes adversary tactic techniques and common knowledge frameworks to generate templates. This existing solution then associates parts of an attack graph with the generated templates, which also relies on the usage of NLP. In general, these existing solutions utilize NLP techniques with fixed rules and word mappings to extract actionable cybersecurity information from threat reports. Often, these existing solutions use a normalization step to convert threat reports into a standard format to improve information extraction precision, but these existing solutions are prone to missing certain details when the threat reports are not high-quality (e.g., not well written, contain unstructured writing, lack step by step attack details, do not use a single subject-action-object format, and the like). By using an LLM, illustrative embodiments mitigate the issues noted above with regard to the existing solutions. The LLM enables illustrative embodiments to be automatic and generalizable.

Thus, illustrative embodiments provide one or more technical solutions that overcome a technical problem with an inability of existing solutions to automatically generate and execute threat hunting queries based on natural language descriptions of indicators of compromise and indicators of behavior derived from composite graphs corresponding to threat reports. As a result, these one or more technical solutions provide a technical effect and practical application in the field of cybersecurity threat detection.

With reference now to FIG. 2, a diagram illustrating an example of a threat hunting query generation system based on threat report processing is depicted in accordance with an illustrative embodiment. Threat hunting query generation system 201 may be implemented in a computing environment, such as computing environment 100 in FIG. 1. Threat hunting query generation system 201 is a collection of hardware and software components for automatically generating and executing threat hunting queries based on natural language descriptions of indicators of compromise and indicators of behavior derived from composite graphs corresponding to threat reports.

In this example, threat hunting query generation system 201 includes computer 202, client device 204, and network 206. Computer 202 may be, for example, computer 101 in FIG. 1. Client device 204 may be, for example, EUD 103 in FIG. 1. Network 206 may be, for example, a cloud environment such as public cloud 105, private cloud 106, or the like. Network 206 may also represent a set of computers or other types of data processing systems within an environment. However, it should be noted that threat hunting query generation system 201 is intended as an example only and not as a limitation on illustrative embodiments. For example, threat hunting query generation system 201 may include any number of computers, client devices, networks, and other devices and components not shown.

In this example, user 208, utilizing client device 204, sends threat report 210 to computer 202 for processing. Threat report 210 corresponds to a newly discovered cybersecurity threat.

At 212, computer 202 identifies system entities 214 included in threat report 210 using, for example, natural language processing and machine learning. System entities 214 may include, for example, files, processes, network addresses, file hashes, malicious actors, and the like. At 216, computer 202 also identifies cybersecurity-related sentences 218 contained within threat report 210. Further, computer 202 identifies local sentence context 220 corresponding to each of cybersecurity-related sentences 218.

Computer 202 inputs system entities 214, cybersecurity-related sentences 218, and local sentence context 220 into LLM 222 for analysis. At 224, LLM 222 identifies system interactions between system entities 214 based on analyzing the descriptions of the relationships between system entities 214 within cybersecurity-related sentences 218 and local sentence context 220.

At 226, LLM 222 generates a subgraph for each of cybersecurity-related sentences 218 based on analyzing the relationships between system entities 214 described within cybersecurity-related sentences 218 and local sentence context 220. At 228, LLM 222 performs subgraph enrichment of the subgraphs of cybersecurity-related sentences 218 by incorporating additional relevant details corresponding to certain system entities and system interactions extracted from local sentence context 220 and other portions of threat report 210 into the subgraphs.

At 230, computer 202 generates composite graph 232 by combining all of the subgraphs corresponding to cybersecurity-related sentences 218 describing the system interactions between system entities associated with the newly discovered cybersecurity threat. At 234, computer 202 generates natural language descriptions of indicators of compromise and indicators of behavior based on analyzing composite graph 232.

At 236, computer 202 generates a threat hunting query corresponding to the newly discovered cybersecurity threat based on the natural language descriptions of indicators of compromise and indicators of behavior. Computer 202 executes the threat hunting query on data 238 of logging system 240 corresponding to network 206. In response to detecting that the newly discovered cybersecurity threat is present in network 206 while running the threat hunting query on data 238, computer 202 performs a set of action steps to prevent the newly discovered cybersecurity threat from causing issues in network 206.

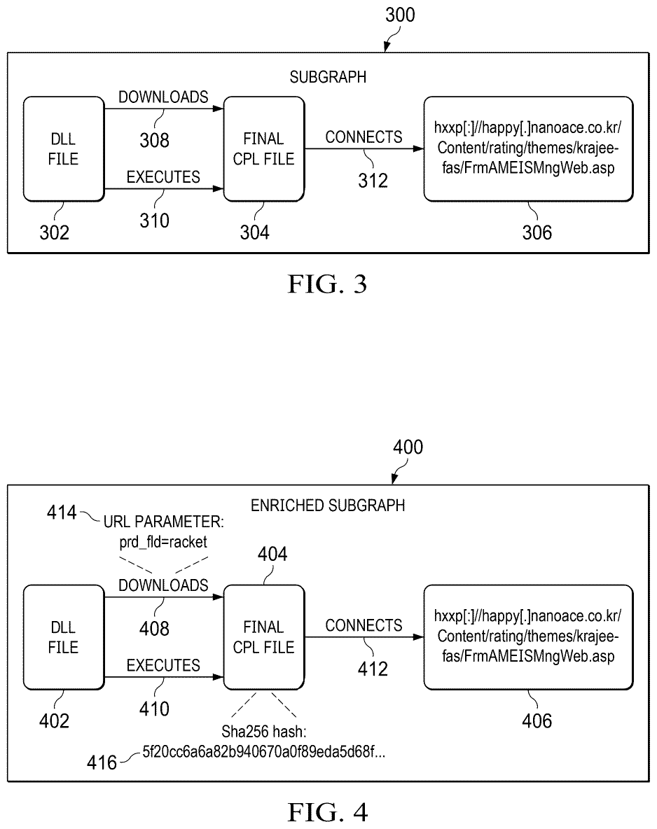

With reference now to FIG. 3, a diagram illustrating an example of a subgraph is depicted in accordance with an illustrative embodiment. Subgraph 300 may be implemented in a computer, such as, for example, computer 202 in FIG. 2 or computer 101 in FIG. 1.

In this example, subgraph 300 includes system entity 302, system entity 304, system entity 306, system interaction 308, system interaction 310, and system interaction 312. However, subgraph 300 is intended as an example only and not as a limitation on illustrative embodiments. For example, subgraph 300 may contain fewer or more system entities and system interactions than shown.

The computer uses an LLM, such as LLM 222 in FIG. 2, to identify the system interactions between the system entities and then generate subgraph 300. For example, the computer provides the LLM with a list of system entities and cybersecurity-related sentences that the computer identified in a threat report, such as threat report 210 in FIG. 2.

For each identified cybersecurity-related sentence in the threat report, the LLM identifies a local sentence context surrounding that particular cybersecurity-related sentence. If the LLM identifies that one or more system interactions exist between two system entities based on a particular cybersecurity-related sentence and its corresponding local sentence context, then the LLM labels an edge representing that particular system interaction between nodes representing the corresponding system entities.

In this example, the identified cybersecurity-related sentence is: “The file is run and the file downloads and executes a backdoor payload file (final.cpl).” The local sentence context before the identified cybersecurity-related sentence is: “This (dll file) is injected into the legitimate system management software INISAFE Web EX Client.” The local sentence context after the identified cybersecurity-related sentence is: “The file (final.cpl) is a . . . . The malware connects to, downloads, decodes, and executes shellcode from the following remote location: hxxp[:]//happy[.]nanoace.co.kr/Content/rating/themes/krajee-fas/FrmAMEISMngWeb.asp.” It should be noted that the LLM does not need a fixed mapping to identify the system interactions to generate subgraph 300.

With reference now to FIG. 4, a diagram illustrating an example of an enriched subgraph is depicted in accordance with an illustrative embodiment. Enriched subgraph 400 may be implemented by an LLM, such as LLM 222 in FIG. 2.

In this example, enriched subgraph 400 includes system entity 402, system entity 404, system entity 406, system interaction 408, system interaction 410, and system interaction 412, such as system entity 302, system entity 304, system entity 306, system interaction 308, system interaction 310, and system interaction 312 of subgraph 300 in FIG. 3. The LLM performs subgraph enrichment by adding additional information, such as system entity aliases, related commands lines, and the like, extracted from sentence local context that is helpful for threat hunting query generation.

In this example, the identified cybersecurity-related sentence includes: “. . . executes a backdoor payload file (final.cpl).” The local sentence context indicates that “file (final.cpl) includes SHA-256 hash: 5f20cc6a6a82b940670a0f89eda5d68f . . . from a command-and-control server with the URL parameter key/values ‘prd_fld=racket’.” Thus, the LLM adds additional details 414 to system interaction 408 and additional details 416 to system entity 404. It should be noted that the LLM can resolve complex implicit relationships described in the threat report.

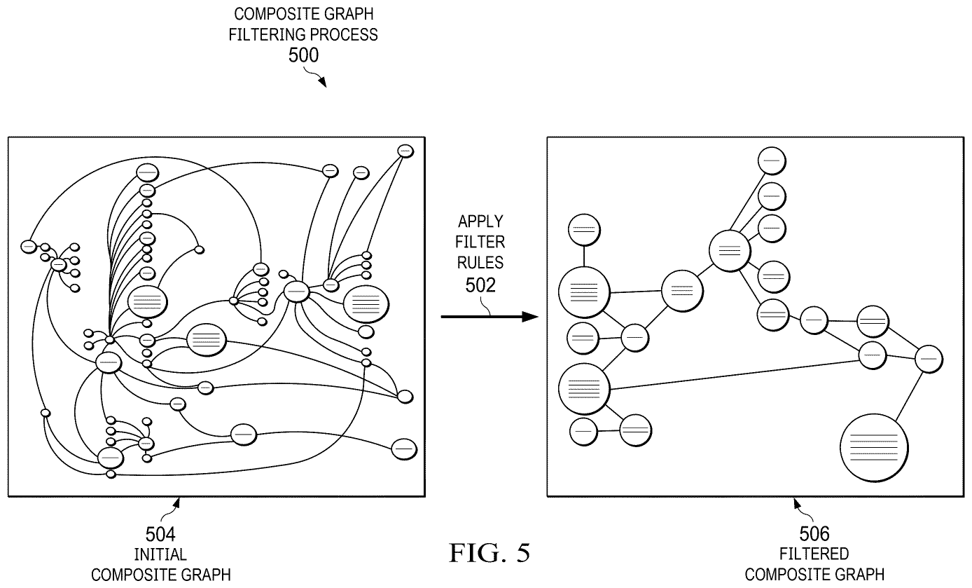

With reference now to FIG. 5, a diagram illustrating an example of a composite graph filtering process is depicted in accordance with an illustrative embodiment. Composite graph filtering process 500 may be implemented in a computer, such as, for example, computer 202 in FIG. 2.

In this example, at 502, the computer applies filtering rules to initial composite graph 504 to generate filtered composite graph 506. Filtered composite graph 506 may be, for example, composite graph 232 in FIG. 2. The computer applies the filtering rules to, for example, remove duplicate or redundant information from initial composite graph 504.

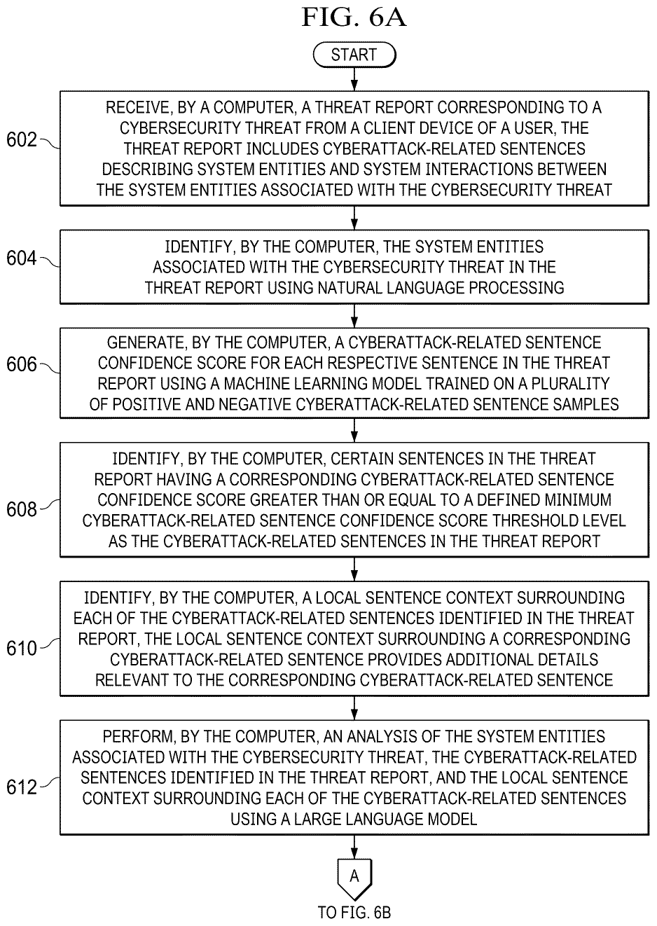

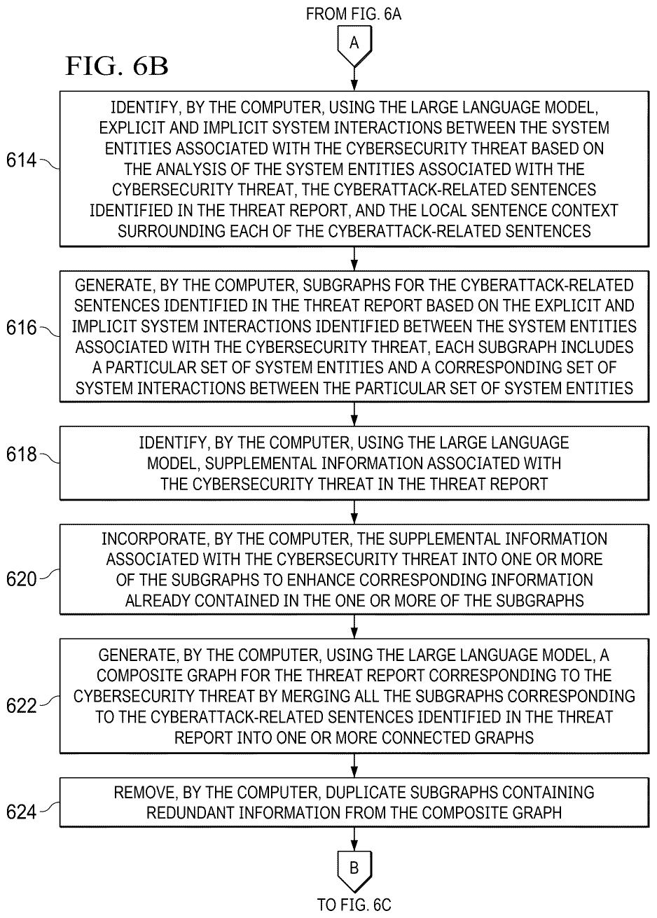

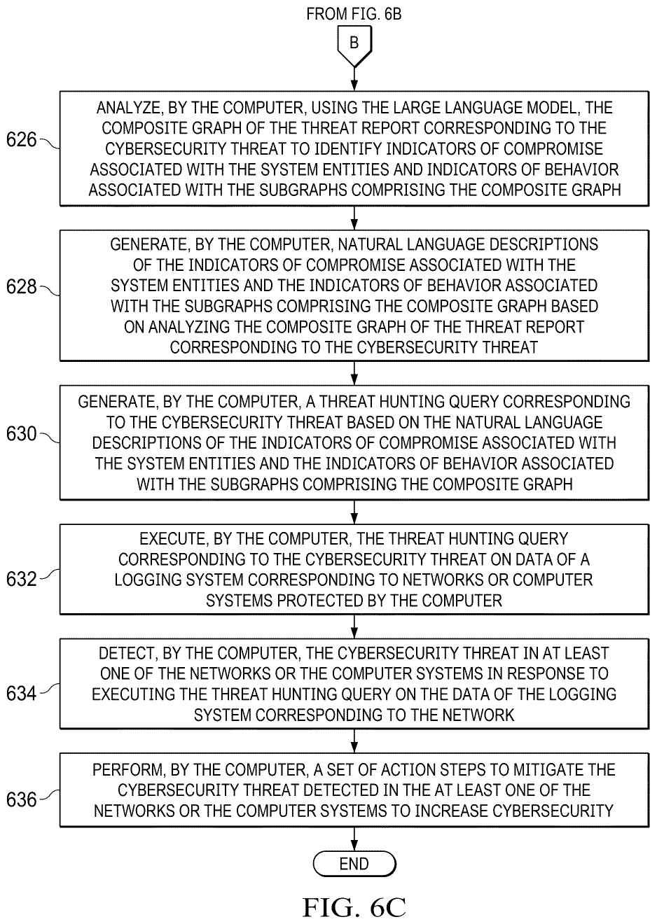

With reference now to FIGS. 6A-6C, a flowchart illustrating a process for generating indicators of compromise and indicators of behavior from threat report graphs is shown in accordance with an illustrative embodiment. The process shown in FIGS. 6A-6C may be implemented in a computer, such as, for example, computer 101 in FIG. 1 or computer 202 in FIG. 2. For example, the process shown in FIGS. 6A-6C may be implemented by threat report processing code 200 in FIG. 1.

The process begins when the computer receives a threat report corresponding to a cybersecurity threat from a client device of a user (step 602). The threat report includes cyberattack-related sentences describing system entities and system interactions between the system entities associated with the cybersecurity threat. In response to receiving the threat report, the computer identifies the system entities associated with the cybersecurity threat in the threat report using natural language processing (step 604).

In addition, the computer generates a cyberattack-related sentence confidence score for each respective sentence in the threat report using a machine learning model trained on a plurality of positive and negative cyberattack-related sentence samples (step 606). Further, the computer identifies certain sentences in the threat report having a corresponding cyberattack-related sentence confidence score greater than or equal to a defined minimum cyberattack-related sentence confidence score threshold level as the cyberattack-related sentences in the threat report (step 608). Furthermore, the computer identifies a local sentence context surrounding each of the cyberattack-related sentences identified in the threat report (step 610). The local sentence context surrounding a corresponding cyberattack-related sentence provides additional details relevant to the corresponding cyberattack-related sentence.

The computer performs an analysis of the system entities associated with the cybersecurity threat, the cyberattack-related sentences identified in the threat report, and the local sentence context surrounding each of the cyberattack-related sentences using a large language model (step 612). It should be noted that the large language model is trained to follow instructions (i.e., the large language model is instruction tuned) and as such is provided with instructions and examples to identify explicit and implicit system interactions between system entities without additional training. The computer, using the large language model, identifies explicit and implicit system interactions between the system entities associated with the cybersecurity threat based on the analysis of the system entities associated with the cybersecurity threat, the cyberattack-related sentences identified in the threat report, and the local sentence context surrounding each of the cyberattack-related sentences (step 614).

The computer generates subgraphs for the cyberattack-related sentences identified in the threat report based on the explicit and implicit system interactions identified between the system entities associated with the cybersecurity threat (step 616). Each subgraph includes a particular set of system entities and a corresponding set of system interactions between the particular set of system entities.

The computer, using the large language model, also identifies supplemental information associated with the cybersecurity threat in the threat report (step 618). In response to identifying the supplemental information associated with the cybersecurity threat in the threat report, the computer incorporates the supplemental information associated with the cybersecurity threat into one or more of the subgraphs to enhance corresponding information already contained in the one or more of the subgraphs (step 620).

Afterward, the computer, using the large language model, generates a composite graph for the threat report corresponding to the cybersecurity threat by merging all the subgraphs corresponding to the cyberattack-related sentences identified in the threat report into one or more connected graphs (step 622). In addition, the computer removes duplicate subgraphs containing redundant information from the composite graph (step 624).

The computer, using the large language model, analyzes the composite graph of the threat report corresponding to the cybersecurity threat to identify indicators of compromise associated with the system entities and indicators of behavior associated with the subgraphs comprising the composite graph (step 626). The computer generates natural language descriptions of the indicators of compromise associated with the system entities and the indicators of behavior associated with the subgraphs comprising the composite graph based on analyzing the composite graph of the threat report corresponding to the cybersecurity threat (step 628).

The computer generates a threat hunting query corresponding to the cybersecurity threat based on the natural language descriptions of the indicators of compromise associated with the system entities and the indicators of behavior associated with the subgraphs comprising the composite graph (step 630). The computer executes the threat hunting query corresponding to the cybersecurity threat on data of a logging system corresponding to networks or computer systems protected by the computer (step 632).

The computer detects the cybersecurity threat in at least one of the networks or the computer systems in response to executing the threat hunting query on the data of the logging system corresponding to the network (step 634). The computer performs a set of action steps to mitigate the cybersecurity threat detected in the at least one of the networks or the computer systems to increase cybersecurity (step 636). The set of action steps includes at least one of notifying a cybersecurity analyst regarding presence of the cybersecurity threat in the at least one of the networks or the computer systems, isolating the at least one of the networks or the computer systems, identifying a source of the cybersecurity threat, terminating any network connections corresponding to the source of the cybersecurity threat, notifying the cybersecurity analyst regarding the source of the cybersecurity threat, and running software to remove the cybersecurity threat from the at least one of the networks or the computer systems. Thereafter, the process terminates.

Thus, illustrative embodiments of the present disclosure provide a computer-implemented method, computer system, and computer program product for automatically generating and executing threat hunting queries based on natural language descriptions of indicators of compromise and indicators of behavior derived from composite graphs corresponding to threat reports. The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
generating, by a computer, using a large language model, a composite graph for a threat report corresponding to a cybersecurity threat by merging subgraphs corresponding to cyberattack-related sentences identified in the threat report into one or more connected graphs;
analyzing, by the computer, using the large language model, the composite graph of the threat report corresponding to the cybersecurity threat to identify indicators of compromise associated with system entities and indicators of behavior associated with the subgraphs comprising the composite graph;
generating, by the computer, descriptions of the indicators of compromise associated with the system entities and the indicators of behavior associated with the subgraphs comprising the composite graph based on analyzing the composite graph of the threat report corresponding to the cybersecurity threat; and
generating, by the computer, a threat hunting query corresponding to the cybersecurity threat based on the descriptions of the indicators of compromise associated with the system entities and the indicators of behavior associated with the subgraphs comprising the composite graph.

2. The computer-implemented method of claim 1, further comprising:
executing, by the computer, the threat hunting query corresponding to the cybersecurity threat on data of a logging system corresponding to networks or computer systems protected by the computer.

3. The computer-implemented method of claim 2, further comprising:
detecting, by the computer, the cybersecurity threat in at least one of the networks or the computer systems in response to executing the threat hunting query on the data of the logging system corresponding to the networks or the computer systems; and
performing, by the computer, a set of action steps to mitigate the cybersecurity threat detected in at least one of the networks or the computer systems to increase cybersecurity.

4. The computer-implemented method of claim 3, wherein the set of action steps includes at least one of notifying a cybersecurity analyst regarding presence of the cybersecurity threat in at least one of the networks or the computer systems, isolating the at least one of the networks or the computer systems, identifying a source of the cybersecurity threat, terminating network connections corresponding to the source of the cybersecurity threat, notifying the cybersecurity analyst regarding the source of the cybersecurity threat, and running software to remove the cybersecurity threat from the at least one of the networks or the computer systems.

5. The computer-implemented method of claim 1, further comprising:
receiving, by the computer, the threat report corresponding to the cybersecurity threat from a client device of a user, the threat report includes the cyberattack-related sentences describing the system entities and system interactions between the system entities associated with the cybersecurity threat; and
identifying, by the computer, the system entities associated with the cybersecurity threat in the threat report using natural language processing in response to receiving the threat report.

6. The computer-implemented method of claim 1, further comprising:
generating, by the computer, a cyberattack-related sentence confidence score for each respective sentence in the threat report using a machine learning model trained on a plurality of positive and negative cyberattack-related sentence samples;
identifying, by the computer, certain sentences in the threat report having a corresponding cyberattack-related sentence confidence score greater than a defined minimum cyberattack-related sentence confidence score threshold level as the cyberattack-related sentences in the threat report; and
identifying, by the computer, a local sentence context surrounding each of the cyberattack-related sentences identified in the threat report, the local sentence context surrounding a corresponding cyberattack-related sentence provides additional details relevant to the corresponding cyberattack-related sentence.

7. The computer-implemented method of claim 6, further comprising:
performing, by the computer, an analysis of the system entities associated with the cybersecurity threat, the cyberattack-related sentences identified in the threat report, and the local sentence context surrounding each of the cyberattack-related sentences using the large language model that is trained to identify explicit and implicit system interactions between the system entities;
identifying, by the computer, using the large language model, the explicit and implicit system interactions between the system entities associated with the cybersecurity threat based on the analysis of the system entities associated with the cybersecurity threat, the cyberattack-related sentences identified in the threat report, and the local sentence context surrounding each of the cyberattack-related sentences; and
generating, by the computer, the subgraphs for the cyberattack-related sentences identified in the threat report based on the explicit and implicit system interactions identified between the system entities associated with the cybersecurity threat, each subgraph includes a particular set of system entities and a corresponding set of system interactions between the particular set of system entities.

8. The computer-implemented method of claim 1, further comprising:
identifying, by the computer, using the large language model, supplemental information associated with the cybersecurity threat in the threat report; and
incorporating, by the computer, the supplemental information associated with the cybersecurity threat into one or more of the subgraphs to enhance corresponding information already contained in the one or more of the subgraphs in response to identifying the supplemental information associated with the cybersecurity threat in the threat report.

9. The computer-implemented method of claim 1, further comprising:
removing, by the computer, redundant information from the composite graph.

10. A computer system comprising:
a processor set;
one or more computer-readable storage media; and
program instructions stored on the one or more computer-readable storage media to cause the processor set to perform operations comprising:
generating using a large language model, a composite graph for a threat report corresponding to a cybersecurity threat by merging subgraphs corresponding to cyberattack-related sentences identified in the threat report into a one or more connected graphs;
analyzing, using the large language model, the composite graph of the threat report corresponding to the cybersecurity threat to identify indicators of compromise associated with system entities and indicators of behavior associated with the subgraphs comprising the composite graph;
generating descriptions of the indicators of compromise associated with the system entities and the indicators of behavior associated with the subgraphs comprising the composite graph based on analyzing the composite graph of the threat report corresponding to the cybersecurity threat; and
generating a threat hunting query corresponding to the cybersecurity threat based on the descriptions of the indicators of compromise associated with the system entities and the indicators of behavior associated with the subgraphs comprising the composite graph.

11. The computer system of claim 10, wherein the operations further comprise:
executing the threat hunting query corresponding to the cybersecurity threat on data of a logging system corresponding to networks or computer systems protected by the computer system.

12. The computer system of claim 11, wherein the operations further comprise:
detecting the cybersecurity threat in at least one of the networks or the computer systems in response to executing the threat hunting query on the data of the logging system corresponding to the networks or the computer systems; and
performing a set of action steps to mitigate the cybersecurity threat detected in at least one of the networks or the computer systems to increase cybersecurity.

13. The computer system of claim 10, wherein the operations further comprise:
receiving the threat report corresponding to the cybersecurity threat from a client device of a user, the threat report includes the cyberattack-related sentences describing the system entities and system interactions between the system entities associated with the cybersecurity threat; and
identifying the system entities associated with the cybersecurity threat in the threat report using natural language processing in response to receiving the threat report.

14. The computer system of claim 10, wherein the operations further comprise:
generating a cyberattack-related sentence confidence score for each respective sentence in the threat report using a machine learning model trained on a plurality of positive and negative cyberattack-related sentence samples;
identifying certain sentences in the threat report having a corresponding cyberattack-related sentence confidence score greater than a defined minimum cyberattack-related sentence confidence score threshold level as the cyberattack-related sentences in the threat report; and
identifying a local sentence context surrounding each of the cyberattack-related sentences identified in the threat report, the local sentence context surrounding a corresponding cyberattack-related sentence provides additional details relevant to the corresponding cyberattack-related sentence.

15. A computer program product comprising:
one or more computer-readable storage media; and
program instructions stored on the one or more computer-readable storage media to perform operations comprising:
generating, by a computer, using a large language model, a composite graph for a threat report corresponding to a cybersecurity threat by merging subgraphs corresponding to cyberattack-related sentences identified in the threat report into one or more connected graphs;
analyzing, by the computer, using the large language model, the composite graph of the threat report corresponding to the cybersecurity threat to identify indicators of compromise associated with system entities and indicators of behavior associated with the subgraphs comprising the composite graph;
generating, by the computer, descriptions of the indicators of compromise associated with the system entities and the indicators of behavior associated with the subgraphs comprising the composite graph based on analyzing the composite graph of the threat report corresponding to the cybersecurity threat; and
generating, by the computer, a threat hunting query corresponding to the cybersecurity threat based on the descriptions of the indicators of compromise associated with the system entities and the indicators of behavior associated with the subgraphs comprising the composite graph.

16. The computer program product of claim 15, wherein the operations further comprise:
executing, by the computer, the threat hunting query corresponding to the cybersecurity threat on data of a logging system corresponding to networks or computer systems protected by the computer.

17. The computer program product of claim 16, wherein the operations further comprise:
detecting, by the computer, the cybersecurity threat in at least one of the networks or computer systems in response to executing the threat hunting query on the data of the logging system corresponding to the system; and
performing, by the computer, a set of action steps to mitigate the cybersecurity threat detected in the at least one of the networks or the computer systems to increase cybersecurity.

18. The computer program product of claim 15, wherein the operations further comprise:
receiving, by the computer, the threat report corresponding to the cybersecurity threat from a client device of a user, the threat report includes the cyberattack-related sentences describing the system entities and system interactions between the system entities associated with the cybersecurity threat; and
identifying, by the computer, the system entities associated with the cybersecurity threat in the threat report using natural language processing in response to receiving the threat report.

19. The computer program product of claim 15, wherein the operations further comprise:
generating, by the computer, a cyberattack-related sentence confidence score for each respective sentence in the threat report using a machine learning model trained on a plurality of positive and negative cyberattack-related sentence samples;
identifying, by the computer, certain sentences in the threat report having a corresponding cyberattack-related sentence confidence score greater than a defined minimum cyberattack-related sentence confidence score threshold level as the cyberattack-related sentences in the threat report; and
identifying, by the computer, a local sentence context surrounding each of the cyberattack-related sentences identified in the threat report, the local sentence context surrounding a corresponding cyberattack-related sentence provides additional details relevant to the corresponding cyberattack-related sentence.

20. The computer program product of claim 19, wherein the operations further comprise:
performing, by the computer, an analysis of the system entities associated with the cybersecurity threat, the cyberattack-related sentences identified in the threat report, and the local sentence context surrounding each of the cyberattack-related sentences using the large language model that is trained to identify explicit and implicit system interactions between the system entities;
identifying, by the computer, using the large language model, the explicit and implicit system interactions between the system entities associated with the cybersecurity threat based on the analysis of the system entities associated with the cybersecurity threat, the cyberattack-related sentences identified in the threat report, and the local sentence context surrounding each of the cyberattack-related sentences; and
generating, by the computer, the subgraphs for the cyberattack-related sentences identified in the threat report based on the explicit and implicit system interactions identified between the system entities associated with the cybersecurity threat, each subgraph includes a particular set of system entities and a corresponding set of system interactions between the particular set of system entities.
